(19) United States
(12) Patent Application Publication
(10) Pub. No.: US 2025/0327143 A1
(43) Pub. Date: Oct. 23, 2025

(54) A system and method for bottom electrode compound bottom blowing of multi-media of DC electric arc furnace

(71) Applicant: CISDI THERMAL & ENVIRONMENTAL ENGINEERING CO., LTD, Chongqing (CN)

(72) Inventors: Ningchuan Yang, Chongqing (CN); Xuetao Wu, Chongqing (CN); Qiuqiang Shi, Chongqing (CN)

(21) Appl. No.: 18/689,092

(22) PCT Filed: Jul. 26, 2022
(86) PCT No.: PCT/CN2022/107899

§ 371 Date: Apr. 29, 2025

(30) Foreign Application Priority Data
Aug. 25, 2021 (CN) 202110983845.7

(51) Int. Cl. C21C 7/00; C21C 5/52; F27D 11/10; F27D 27/00; H05B 7/08; H05B 7/20

(52) U.S. Cl. CPC C21C 7/0025; C21C 5/5229; F27D 11/10; F27D 27/00; H05B 7/08; H05B 7/20; F27D 2027/002

(57) ABSTRACT

The invention relates to a system and method for bottom electrode compound bottom blowing of multi-media of DC electric arc furnace, which belongs to the field of steelmaking technology. The system includes a plurality of bottom electrodes located at the bottom of furnace, wherein some of the bottom electrodes are bottom blowing electrodes with hollow structures, and some of the bottom blowing electrodes are at least one type of Type I bottom electrode, Type II bottom electrode and Type III bottom electrode; the Type I bottom electrode is used to blow carbonaceous materials into the molten pool to carburize the molten pool to accelerate scrap melting; the Type II bottom electrode is used to blow slagging powder into the molten pool to form molten slag particles in the molten metal to increase the gas-slag-gold three-phase reaction interface area during the dephosphorization reaction; the Type III bottom electrode is used to blow gas into the molten pool to accelerate mass transfer in the molten pool; the system also includes a control unit connected to the bottom blowing electrode to realize online adjustment of the blowing parameters in combination with the power supply intensity of the bottom blowing electrode during the smelting process. The invention can improve production efficiency and reduce consumption of raw and auxiliary materials.

### TECHNICAL FIELD

The invention belongs to the technical field of steelmaking and relates to a system and method for bottom electrode compound bottom blowing of multi-media of DC electric arc furnace.

### BACKGROUND

As one of the main methods of electric arc furnace steelmaking, DC electric arc furnace steelmaking uses the furnace bottom as the positive electrode of the arc current and relies on the action of the current between the electrodes to strengthen the stirring of the molten pool, which improves the kinetic conditions of the molten pool. However, due to its flat furnace structure, the molten pool has weak stirring force and poor kinetic conditions, resulting in a long steelmaking cycle and difficulty in controlling the amount of phosphorus, nitrogen, and oxygen in the molten steel, which always restricts the development of the green and efficient smelting of DC electric arc furnaces.

The main problems are reflected in the following aspects:
(1) The structure of raw materials such as scrap steel for smelting is complex that the nitrogen content is high, and the phosphorus content fluctuates greatly after melting;
(2) The carbon content of the molten pool is low, the carbon-oxygen reaction in the molten pool is insufficient, the flow rate of the molten steel is slow, and the kinetic conditions for dephosphorization and denitrification are poor;
(3) During the smelting process, lime is usually added to the molten pool in the form of blocks whose slag-forming speed is slow. Although the blowing of carbon powder on the furnace wall improves the fluidity of the slag, the utilization rate of carbon powder is still low, the consumption of raw and auxiliary materials is high, and the quality of molten steel is difficult to effectively improve;
(4) Modern electric arc furnace steelmaking generally uses high-power power supply to accelerate scrap steel melting and shorten the smelting cycle, while N₂ in the air ionized by high-temperature electric arc make molten steel easy to absorb nitrogen;
(5) Strengthening the oxygen supply not only improves the smelting efficiency, but also brings about the problems of end-point peroxidation, low metal yield, and high alloy consumption after tapping;
(6) The bottom electrode power supply cause the local temperature of the furnace bottom to be too high, affecting the power supply intensity and life of the bottom electrode.

Therefore, how to improve the metallurgical reaction kinetic conditions of DC electric arc furnace, accelerate the reaction speed at the slag-steel interface, reduce the consumption of raw and auxiliary materials, and improve production efficiency is an urgent technical issue that needs to be solved in the development process of DC electric arc furnace steelmaking towards green and efficient production.

### Invention Content

In view of this, the object of the present invention is to provide a system and method for bottom electrode compound bottom blowing of multi-media of DC electric arc furnace to improve production efficiency.

To achieve the above purpose, the present invention provides the following technical solution:

A system for bottom electrode compound bottom blowing of multi-media of DC electric arc furnace, which includes a plurality of bottom electrodes located at the bottom of furnace, wherein some of the bottom electrodes are bottom blowing electrodes with hollow structures, and some of the bottom blowing electrodes are at least one type of Type I bottom electrode, Type II bottom electrode and Type III bottom electrode; the Type I bottom electrode is used to blow carbonaceous materials into the molten pool to carburize the molten pool to accelerate scrap melting;
the Type II bottom electrode is used to blow slagging powder into the molten pool to form molten slag particles in the molten metal to increase the gas-slag-gold three-phase reaction interface area during the dephosphorization reaction;
the Type III bottom electrode is used to blow gas into the molten pool to accelerate mass transfer in the molten pool; the system also includes a control unit connected to the bottom blowing electrode to realize online adjustment of the blowing parameters in combination with the power supply intensity of the bottom blowing electrode during the smelting process.

Optionally, the Type II bottom electrode and the Type I bottom electrode are arranged adjacent to each other to neutralize the local cold effect produced by the Type I bottom electrode; the Type III bottom electrode is dispersedly arranged to accelerate the flow at the bottom of the molten pool to strengthen the heat exchange between slag and steel.

Optionally, the medium of the carrier gas 1 of the Type I bottom electrode is air, nitrogen or CO₂, and the flow rate of the carrier gas is 0˜1000Nm³/h; the carbonaceous material is carbon powder, coking coal, graphite powder or other carburizing powders, the powder flow rate of a single Type I bottom electrode is 0˜50 kg/min, and the powder particle size is less than or equal to 1 mm.

Optionally, the medium of the carrier gas 2 of the Type II bottom electrode is O₂, O₂—N₂ mixed gas or O₂—CO₂ mixed gas, the flow rate of the carrier gas is 0˜1000 Nm³/h, and the volume flow rate of oxygen is 0˜100%; the slagging powder is lime powder or limestone powder, the powder flow rate of a single Type II bottom electrode is 0˜50 kg/min, and the powder particle size is less than or equal to 1 mm.

Optionally, the pure gas bottom blowing medium of the Type III bottom electrode is at least one type of mixed gases selected from N₂, Ar, CO₂, and O₂, and the bottom blowing intensity is 0˜0.05 Nm³/(min·t).

Optionally, the inner diameter of the cavity of the Type I bottom electrode and the Type II bottom electrode is 4 mm to 25 mm, and the inner diameter of the cavity of the Type III bottom electrode is 0.1 mm to 10 mm.

Optionally, the bottom blowing interface of the bottom blowing electrode and the external medium input interface are insulated.

Optionally, the bottom blowing electrode is integrally installed at the bottom of the electric arc furnace and is filled and wrapped with materials poured from the furnace bottom.

A method for bottom electrode compound bottom blowing of multi-media of DC electric arc furnace, characterized in that some bottom electrode located at the bottom of the furnace is designed as a bottom blowing electrode with a hollow structure, and the bottom blowing electrode is used to blow at least one type of the medium of the gases, carbonaceous materials and slagging powder that can accelerate the mass transfer of the molten pool into the molten pool in the furnace, and it dynamically control the blowing parameters in combination with the power supply strength of the bottom blowing electrode to achieve coordinated operation of bottom blowing and bottom electrode.

The beneficial effects in this invention are:
(1) The system for bottom electrode compound bottom blowing of multi-media of DC electric arc furnace in this application adopts a hollow bottom electrode design. During the smelting process, the solid part of the bottom blowing electrode supplies power to the molten pool, and the hollow part dynamically inputs multiple media into the molten pool to achieve the efficient coordinated operation of bottom blowing and bottom electrode;
(2) The new smelting method of DC electric arc furnace in this application uses bottom blowing electrode to blow carbonaceous materials and slagging powder into the molten pool, which can achieve efficient carbonization of the molten pool, accelerating scrap melting and efficient removal of impurities, while not only reducing the consumption of raw and auxiliary materials but also achieving the smelting endpoint with the phosphorus less than or equal to 0.005% and the nitrogen less than or equal to 50 ppm;
(3) The system for bottom electrode compound bottom blowing of multi-media of DC electric arc furnace in this application can effectively improve the uniformity of the composition and temperature of the molten steel, reduce energy loss during the smelting process, speed up the smelting rhythm, and shorten the smelting cycle by more than or equal to 3 minutes. Also, tons steel power consumption is reduced by more than 10 kWh;
(4) By blowing carbonaceous materials and slagging powder into the molten pool during the steelmaking process of the electric arc furnace, the present invention can effectively control the peroxidation problem at the smelting end point and increase the metal yield by 1 to 3%. At the same time, compared with the electric arc furnaces without bottom blowing function, the alloy yield in the tapping alloying process is increased by 4 to 5%.

Other advantages, objectives and features of the present invention will be illustrated in the following description to some extent, and will be apparent to those skilled in the art based on the following investigation and research to some extent, or can be taught from the practice of the present invention. The objectives and other advantages of the present invention can be realized and obtained through the following description.

### DESCRIPTION OF DRAWINGS

To enable the purpose, the technical solution and the advantages of the present invention to be more clear, the present invention will be preferably described in detail below in combination with the drawings, wherein:

FIG. 1 is a schematic diagram of the system for bottom electrode compound bottom blowing of multi-media of DC electric arc furnace in the present invention;

FIG. 2 is a cross-sectional schematic diagram of the distribution of bottom blowing electrode compound bottom blowing of multi-media in Embodiment 1 of the present invention;

FIG. 3 is a schematic diagram of the Type I bottom electrode process in Embodiment 1 of the present invention;

FIG. 4 is a schematic diagram of the Type II bottom electrode process in Embodiment 1 of the present invention;

FIG. 5 is a schematic diagram of the Type III bottom electrode process in Embodiment 1 of the present invention;

FIG. 6 is a cross-sectional schematic diagram of the distribution of bottom blowing electrode of multi-media in Embodiment 2 of the present invention.

In the figures:
Type III bottom electrode bottom blowing control system—1, Type I bottom electrode bottom blowing control system—2, Type II bottom electrode bottom blowing control system—3, Type III bottom electrode system distributor—4, Type I bottom electrode system distributor—5, Type II Bottom electrode system distributor—6, insulating joint—7, bottom blowing electrode—8, bottom blowing electrode air cooling air inlet—9, bottom electrode conductive copper bar—10.

### DETAILED DESCRIPTION

Embodiments of the present invention are described below through specific embodiments. Those skilled in the art can understand other advantages and effects of the present invention easily through the disclosure of the description. The present invention can also be implemented or applied through additional different specific embodiments. All details in the description can be modified or changed based on different perspectives and applications without departing from the spirit of the present invention. It should be noted that the figures provided in the following embodiments only exemplarily explain the basic conception of the present invention, and if there is no conflict, the following embodiments and the features in the embodiments can be mutually combined.

Wherein the drawings are only used for exemplary description, are only schematic diagrams rather than physical diagrams, and shall not be understood as a limitation to the present invention. In order to better illustrate the embodiments of the present invention, some components in the drawings may be omitted, scaled up or scaled down, and do not reflect actual product sizes. It should be understandable for those skilled in the art that some well-known structures and description thereof in the drawings may be omitted.

Same or similar reference signs in the drawings of the embodiments of the present invention refer to same or similar components. It should be understood in the description of the present invention that terms such as “upper”, “lower”, “left”, “right”, “front” and “back” indicate direction or position relationships shown based on the drawings, and are only intended to facilitate the description of the present invention and the simplification of the description rather than to indicate or imply that the indicated device or element must have a specific direction or constructed and operated in a specific direction, and therefore, the terms describing position relationships in the drawings are only used for exemplary description and shall not be understood as a limitation to the present invention; for those ordinary skilled in the art, the meanings of the above terms may be understood according to specific conditions.

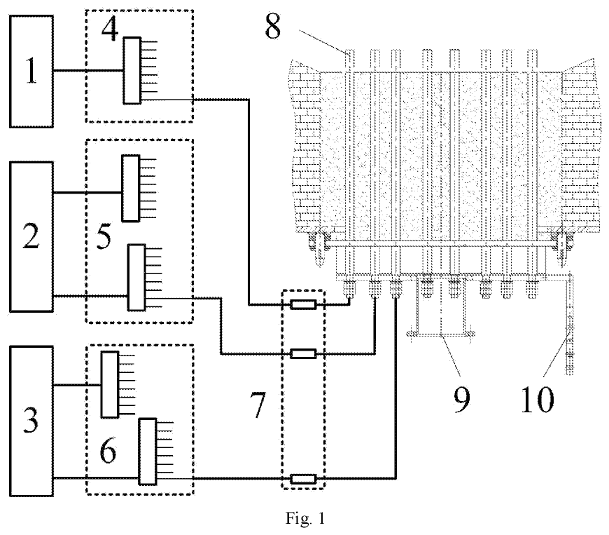

As shown in FIG. 1 to FIG. 6, a system for bottom electrode compound bottom blowing of multi-media of DC electric arc furnace, which includes a plurality of bottom electrodes located at the bottom of furnace; some of the bottom electrodes are bottom blowing electrodes 8 with hollow structures, and the bottom blowing electrode 8 is needle-shaped and extends into the molten pool in the furnace; some of the bottom blowing electrodes 8 are at least one type of Type I bottom electrode, Type II bottom electrode and Type III bottom electrode;
the Type I bottom electrode is used to blow carbonaceous materials into the molten pool to carburize the molten pool to accelerate scrap melting;
the Type II bottom electrode is used to blow slagging powder into the molten pool to form molten slag particles in the molten metal to increase the gas-slag-gold three-phase reaction interface area during the dephosphorization reaction;
the Type III bottom electrode is used to blow gas into the molten pool to accelerate mass transfer in the molten pool;
the system also includes a control unit connected to the bottom blowing electrode 8 to realize online adjustment of the blowing parameters in combination with the power supply intensity of the bottom blowing electrode 8 during the smelting process.

In order to prevent the center of the bottom electrode from being easily blocked due to excessive cooling of the molten steel due to carburization of the molten pool for Type I bottom electrodes, and the accelerated burning of the furnace bottom caused by excessive local temperature of the molten steel caused by oxidation of molten steel for Type II bottom electrodes, the present invention divides the bottom electrode into several areas. The bottom electrode, Type I bottom electrode, Type II bottom electrode and type III bottom electrode in each area cooperate with each other, and the bottom electrode supplies power to the molten pool. Wherein, the Type III bottom electrode is dispersed to accelerate the heat and mass transfer between the molten steel, strengthen the heat exchange between the slag steel and balance the thermal effects brought by the Type I bottom electrode and the Type II bottom electrode areas; the Type II bottom electrode and the Type I bottom electrode are adjacent to each other that the Type II bottom electrode slows down the cooling effect of the molten steel brought by the reaction area of the Type I bottom electrode, so that the temperature of the molten steel at the furnace bottom is quickly neutralized and evened to achieve the purpose of synchronous burning of each bottom blowing electrode 8. According to the requirements of the smelting process, the quantity ratio of each type of bottom blowing electrode 8 in each area can be adjusted, and the distribution ratio ranges from 0 to 100%.

The invention realizes efficient carburization of the molten pool, rapid slag formation, impurity removal and powerful stirring, which improves production efficiency and reduces the consumption of raw and auxiliary materials.

Optionally, the medium of the carrier gas 1 of the Type I bottom electrode is air, nitrogen or CO₂, and the flow rate of the carrier gas is 0˜1000Nm³/h; the carbonaceous material is carbon powder, coking coal, graphite powder or other carburizing powders, the powder flow rate of a single Type I bottom electrode is 0˜50 kg/min, and the powder particle size is less than or equal to 1 mm.

Optionally, the medium of the carrier gas 2 of the Type II bottom electrode is O₂, O₂—N₂ mixed gas or O₂—CO₂ mixed gas, the flow rate of the carrier gas is 0˜1000 Nm³/h, and the volume flow rate of oxygen is 0˜100%; the slagging powder is lime powder or limestone powder, the powder flow rate of a single Type II bottom electrode is 0˜50 kg/min, and the powder particle size is less than or equal to 1 mm.

Optionally, the pure gas bottom blowing medium of the Type III bottom electrode is at least one type of mixed gases selected from N₂, Ar, CO₂, and O₂, and the bottom blowing intensity is 0˜0.05 Nm³/(min·t).

Optionally, the inner diameter of the cavity of the Type I bottom electrode and the Type II bottom electrode is 4 mm to 25 mm, and the inner diameter of the cavity of the Type III bottom electrode is 0.1 mm to 10 mm.

Optionally, the inner diameter of the cavity of the Type I bottom electrode and the Type II bottom electrode is 12 mm or 14 mm, and the inner diameter of the cavity of the Type III bottom electrode is 4 mm or 5 mm.

Optionally, the bottom blowing interface of the bottom blowing electrode 8 and the external medium input interface are insulated to prevent the medium input process from being electrically conductive with the bottom electrode, causing system failure or even safety accidents.

Optionally, the bottom blowing electrode 8 is integrally installed at the bottom of the electric arc furnace and is filled and wrapped with materials poured from the furnace bottom.

Optionally, the control unit includes a system distributor connected to the bottom blow electrode 8 and a control system connected to the system distributor. The system distributor includes a Type I bottom electrode system distributor 5 respectively connected to Type I bottom electrode and Type II bottom electrode system distributor 6. The control system includes a Type I bottom electrode bottom blowing control system 2 and a Type II bottom electrode bottom blowing control system 3 respectively connected to the Type I bottom electrode system distributor 5 and the Type II bottom electrode system distributor 6.

The invention also provides a method for bottom electrode compound bottom blowing of multi-media of DC electric arc furnace, characterized in that some bottom electrode located at the bottom of the furnace is designed as a bottom blowing electrode with a hollow structure, and the bottom blowing electrode is used to blow at least one type of the medium of the gases, carbonaceous materials and slagging powder that can accelerate the mass transfer of the molten pool into the molten pool in the furnace, and it dynamically control the blowing parameters in combination with the power supply strength of the bottom blowing electrode to achieve coordinated operation of bottom blowing and bottom electrode.

By designing part of the bottom electrode as a bottom blowing electrode 8 with a hollow structure, the present invention realizes the composite metallurgical function of electrification and bottom blowing of multi-media. During the smelting process, the solid part of the bottom blowing electrode 8 supplies power to the molten pool, and the hollow part dynamically blows gas, carrier gas-carbonaceous material and carrier gas-slagging powder into the molten pool respectively. Also, combined with the power supply of the bottom electrode, the multi-media bottom blowing of each bottom blowing electrode 8 cooperate with each other that the bottom blowing of multi-media can complete efficient carburization, rapid slag formation, impurity removal and powerful stirring in the molten pool while cooling the bottom electrode. At the same time, the composition and temperature of the molten pool are quickly and evenly distributed to shorten the smelting cycle by at least 3 minutes, the metal yield is increased by 1˜3%, the smelting end point of phosphorus is less than or equal to 0.005%, and the smelting end point of nitrogen is less than or equal to 50 ppm. Compared with the electric arc furnaces without bottom blowing function, the alloy yield in the tapping alloying process is increased by 4 to 5%.

### Embodiment 1

The present invention is applied to a 100t DC electric arc furnace. The schematic diagram of the composite bottom blowing of multi-media electrode system is shown in FIG. 1. The Type III bottom electrode bottom blowing control system 1 is connected to the Type III bottom electrode system distributor 4. The Type III bottom electrode system distributor 4 evenly transports the bottom blowing gas to the bottom blowing electrode 8 of the hollow structure to complete the transportation task of the bottom blowing gas during the smelting process; the Type I bottom electrode bottom blowing control system 2 and the Type II bottom electrode bottom blowing control system 3 are respectively connected with the Type I bottom electrode system distributor 5 and the Type II bottom electrode system distributor 6. Each group of distributors is connected to the corresponding bottom blowing electrode 8. The powder is evenly transported to each bottom blowing electrode 8 through the distributor to complete the tasks of carburization and dephosphorization during the smelting process. The delivery pipe between the distributor and the bottom blowing electrode 8 is provided with an insulating joint 7 to ensure the safety of the blowing system. All bottom electrodes are connected to the bottom electrode conductive copper bar 10, and the bottom blowing electrode air cooling air inlet 9 is provided on the electrode bottom plate.

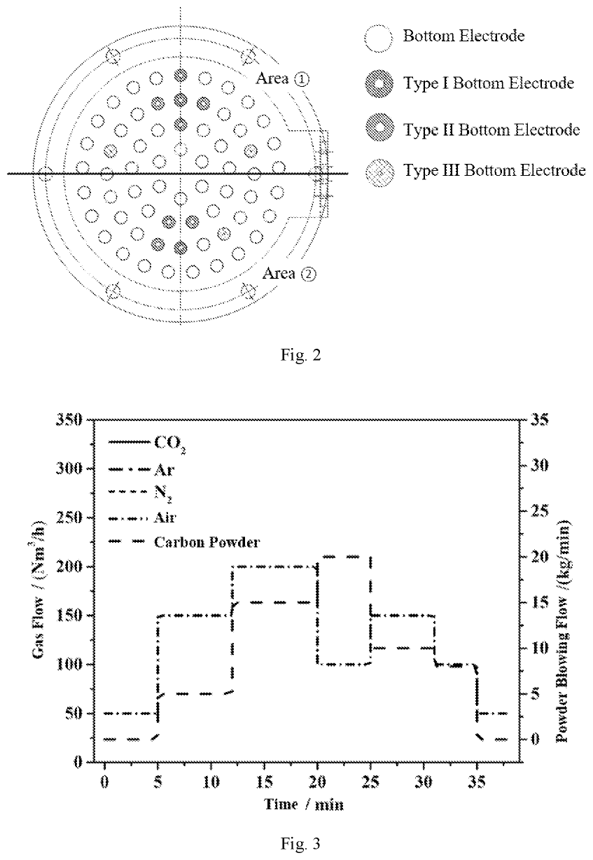

The bottom electrode of the furnace uses air-cooled needle-shaped bottom blowing electrode 8, and the bottom electrode is arranged in a ring on the electrode bottom plate. The bottom electrode has a diameter of 50 mm and is made of stainless steel. As shown in FIG. 2, the bottom electrode area is divided into two reaction areas according to the solid line as shown in the figure, area 1 uses 3 Type I bottom electrodes, 2 Type II bottom electrodes and 2 Type III bottom electrodes, area 2 uses 2 Type I bottom electrodes, 2 Type II bottom electrodes and 2 Type III bottom electrodes. Type II bottom electrodes and Type I bottom electrodes are arranged adjacent to each other to neutralize the local cold effect produced by Type I bottom electrodes and ensure simultaneous erosion of the bottom electrodes; Type III bottom electrodes are arranged separately to accelerate the flow at the bottom of the molten pool and strengthen the heat exchange in the gap between slag and steel. The inner diameter of the hole of the Type III bottom electrode is 4 mm, and the inner diameter of the hole of the Type I bottom electrode and Type II bottom electrode is 12 mm.

The carbonaceous material and slagging powder are carbon powder and lime powder respectively. The particle size of the powder is 200 μm, and the powder blowing rate of a single bottom blowing electrode 8 is 0˜20 kg/min. The carrier gas 1 of the Type I bottom electrode is air, the carrier gas 2 of the Type II bottom electrode is O₂, and the gas flow rate of a single bottom blowing electrode 8 is 50˜500 Nm³/h. The bottom blowing stirring gas is Ar, and the gas flow rate of a single Type III bottom electrode is 50˜400 NL/min.

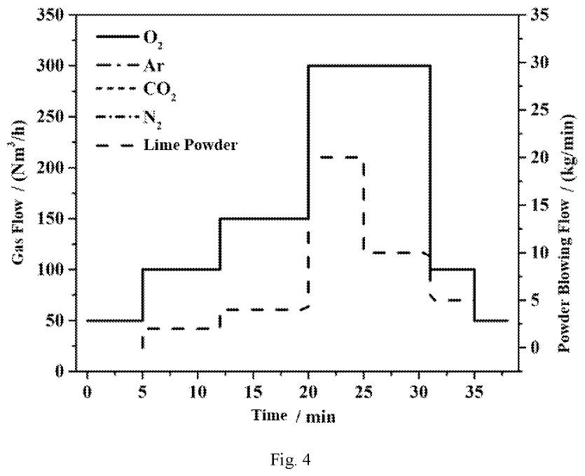

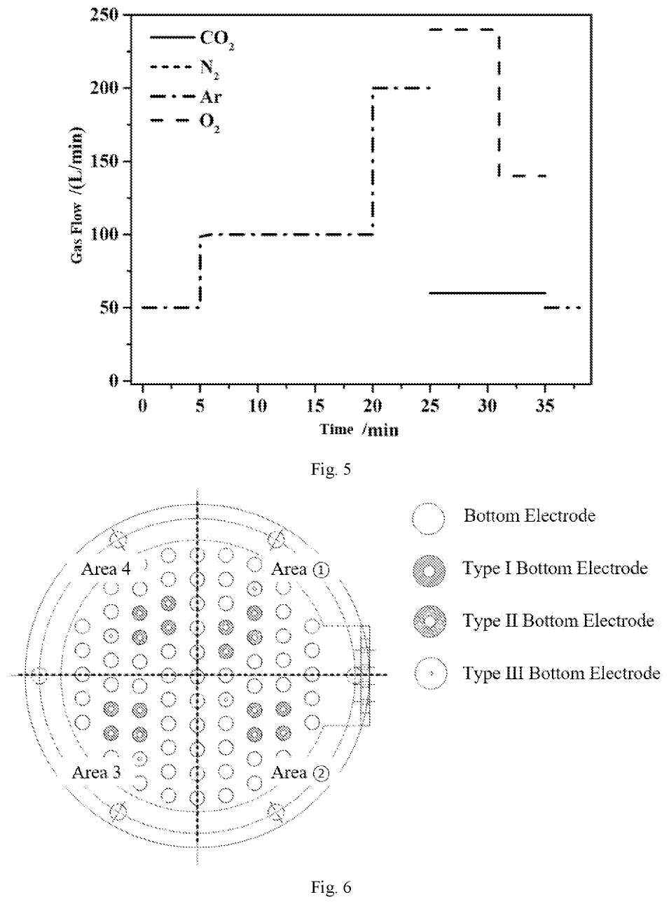

The process diagrams of a single Type I bottom electrode, Type II bottom electrode and type III bottom electrode are shown in FIG. 3, FIG. 4 and FIG. 5 respectively. The specific steps are as follows:
(1) (0˜5 min) In the electric arc furnace charging stage, the Type I bottom electrodes and the Type II bottom electrodes blow air and O₂ into the molten pool respectively with a flow rate 50 Nm³/h, and the Type III bottom electrodes blow Ar into the molten pool with a flow rate 50 NL/min to prevent the bottom blowing electrode 8 from clogging.
(2) (6˜12 min) During the carburization stage of the molten pool, the Type I bottom electrode blows air-toner powder into the molten pool with a powder blowing rate 5 kg/min and an air flow 150 Nm³/h; the Type II bottom electrode blows oxygen-lime powder into the molten pool with a powder blowing rate 2 kg/min, oxygen flow rate 100 Nm³/h, and the Type III bottom electrode blows Ar into the molten pool with a flow rate 100 NL/min.
(3) (13˜20 min) During the scrap melting stage, the height of the molten pool rises. In order to accelerate the melting of scrap steel, the Type I bottom electrode blows air-carbon powder into the molten pool with a powder blowing rate 15 kg/min and an air flow 200 Nm³/h to increase the carburizing rate of the molten pool; at the same time, the Type II bottom electrode blows oxygen-lime powder into the molten pool with a powder blowing rate 4 kg/min and an oxygen flow rate 150 Nm³/h to dephosphorize the molten steel; the Type III bottom electrode blows Ar into the molten pool with a flow rate 100 NL/min to accelerates the flow of molten pool.
(4) (21˜25 min) In the clearing stage, the Type II bottom electrode blows oxygen-lime powder into the molten pool with a powder blowing rate 20 kg/min and an oxygen flow rate 300 Nm³/h to achieve rapid and deep dephosphorization; the Type I bottom electrode blows air-carbon powder into the molten pool with a powder blowing rate 4 kg/min and an air flow rate 100 Nm³/h to use the carbon-oxygen reaction to accelerate mass transfer in the molten pool; the Type III bottom electrode blows Ar into the molten pool with a flow rate 200 NL/min.
(5) (26˜31 min) In the heating stage, the Type I bottom electrode blows air-carbon powder into the molten pool with a powder blowing rate 10 kg/min and an air flow 150 Nm³/h; the Type II bottom electrode blows oxygen-lime powder into the molten pool with a powder blowing rate 10 kg/min and an oxygen flow rate 300 Nm³/h, the Type III bottom electrode blows O₂—CO₂ mixed gas into the molten pool with a CO2 volume ratio 20% and a flow rate is 300 NL/min to strengthen the reaction in the molten pool.
(6) (32˜35 min) The Type I bottom electrode blows air-carbon powder into the molten pool with a powder blowing rate 8 kg/min and an air flow 100 Nm³/h; the Type II bottom electrode blows oxygen-lime powder into the molten pool with a powder blowing rate 5 kg/min and a carrier gas flow 100 Nm³/h, the Type III bottom electrode blows O₂—CO₂ into the molten pool with a flow rate 200 NL/min and a CO2 volume ratio 30%.
(7) (36˜38 min) During the tapping stage of the electric arc furnace, the Type I bottom electrode and the Type II bottom electrode respectively blow air and O₂ into the molten pool with a flow rate 50 Nm³/h; the Type III bottom electrode blows Ar into the molten pool with a flow rate 50 NL/min to prevent bottom blowing electrode 8 from clogging.

After adopting the method of the present invention, the electric arc furnace smelting cycle is shortened by 5 minutes, the power consumption per ton of steel is reduced by 10 kWh, the phosphorus content in the molten steel is less than 0.005%, the nitrogen content is controlled below 50 ppm, the metal yield is increased by 2%, and the alloy yield rate during the tapping alloying process is increased by 3% on average. The cleanliness of molten steel is significantly improved, and the smelting rhythm is significantly improved.

### Embodiment 2

The present invention is applied to a 150t continuous charging DC electric arc furnace. The furnace bottom electrode adopts an air-cooled needle-shaped bottom blowing electrode 8. The bottom electrode adopts a strip arrangement on the electrode bottom plate. The bottom electrode has a diameter of 50 mm and is made of stainless steel. As shown in FIG. 6. the bottom electrode area is divided into four reaction areas according to the dotted line as shown in the figure. In each area, 2 Type I bottom electrodes, 2 Type II bottom electrodes and 1 Type III bottom electrode are used, and the rest are solid bottom electrodes; Type II bottom electrodes and Type I bottom electrodes are arranged adjacent to each other to neutralize the local cold effect produced by Type I bottom electrodes and ensure simultaneous erosion of the bottom electrodes; Type III bottom electrodes are arranged separately to accelerate the flow at the bottom of the molten pool and strengthen the heat exchange in the gap between slag and steel. The inner diameter of the hole of the Type III bottom electrode is 5 mm, and the inner diameter of the hole of the Type I bottom electrode and Type II bottom electrode is 14 mm.

The carbonaceous material and slagging powder are graphite powder and lime powder respectively. The particle size of the powder is 100 μm, and the powder blowing rate of a single bottom blowing electrode 8 is 0˜20 kg/min. The carrier gas 1 is air, the carrier gas 2 is O₂, and the gas flow rate of a single bottom blowing electrode 8 is 50˜500 Nm³/h. The bottom blowing stirring gas is Ar, and the gas flow rate of a single Type III bottom electrode is 50˜400 NL/min.

The operation steps of each stage are as follows:
(1) (0˜8 min) In the electric arc furnace charging stage, the Type I bottom electrodes blows air-graphite powder into the molten pool with a powder blowing rate 10 kg/min and an air flow rate 150 Nm³/h to add carbon to the molten pool; the Type II bottom electrodes blow oxygen-lime powder into the molten pool with a powder blowing rate 2 kg/min and an oxygen flow rate 100 NL/min, and the Type III bottom electrodes blow Ar into the molten pool with a flow rate 100 NL/min to prevent the bottom blowing electrode 8 from clogging.
(2) (9˜22 min) During the scrap melting stage, the height of the molten pool rises. In order to accelerate the melting of scrap steel, the Type I bottom electrode blows air-graphite powder into the molten pool with a powder blowing rate 20 kg/min and an air flow 200 Nm³/h to increase the carburizing rate of the molten pool; at the same time, the Type II bottom electrode blows oxygen-lime powder into the molten pool with a powder blowing rate 6 kg/min and an oxygen flow rate 150 Nm³/h to dephosphorize the molten steel; the Type III bottom electrode blows Ar into the molten pool with a flow rate 150 NL/min to accelerates the flow of molten pool.
(3) (23˜26 min) In the clearing stage, the Type II bottom electrode blows oxygen-lime powder into the molten pool with a powder blowing rate 25 kg/min and an oxygen flow rate 300 Nm³/h to achieve rapid and deep dephosphorization; the Type I bottom electrode blows air-graphite powder into the molten pool with a powder blowing rate 6 kg/min and an air flow rate 120 Nm³/h to use the carbon-oxygen reaction to accelerate mass transfer in the molten pool; the Type III bottom electrode blows Ar into the molten pool with a flow rate 250 NL/min.
(4) (27˜30 min) In the heating stage, the Type I bottom electrode blows air-graphite powder into the molten pool with a powder blowing rate 10 kg/min and an air flow 150 Nm³/h; the Type II bottom electrode blows oxygen-lime powder into the molten pool with a powder blowing rate 10 kg/min and an oxygen flow rate 300 Nm³/h, the Type III bottom electrode blows O₂—CO₂ mixed gas into the molten pool with a CO2 volume ratio 30% and a flow rate is 400 NL/min to strengthen the reaction in the molten pool.
(5) (31˜33 min) The Type I bottom electrode blows air-carbon powder into the molten pool with a powder blowing rate 8 kg/min and an air flow 100 Nm³/h; the Type II bottom electrode blows oxygen-lime powder into the molten pool with a powder blowing rate 5 kg/min and a carrier gas flow 100 Nm³/h, the Type III bottom electrode blows O₂—CO₂ into the molten pool with a flow rate 250 NL/min and a CO2 volume ratio 30% to prevent local peroxidation of the molten steel.
(6) (34˜37 min) During the tapping stage of the electric arc furnace, the Type I bottom electrode and the Type II bottom electrode respectively blow air and O₂ into the molten pool with a flow rate 50 Nm³/h; the Type III bottom electrode blows Ar into the molten pool with a flow rate 50 NL/min to prevent bottom blowing electrode 8 from clogging.

After adopting the method of the present invention, the electric arc furnace smelting cycle is shortened by 7 minutes, the power consumption per ton of steel is reduced by 15 kWh, the phosphorus content in the molten steel is less than 0.004%, the nitrogen content is controlled below 50 ppm, the metal yield is increased by 1%, and the alloy yield rate during the tapping alloying process is increased by 4% on average. The cleanliness of molten steel is significantly improved, and the smelting rhythm is significantly improved.

The invention is suitable for the smelting process of 10-1000t DC electric arc furnace. Through multiple bottom blowing electrodes 8 arranged on the bottom electrode chassis, the composite metallurgical function of electrification and bottom blowing of multi-media is realized. During the smelting process, the supply power of bottom electrode is combined, and at the same time, bottom blowing electrode 8 dynamically blows gas, carrier gas 1-carbonaceous material and carrier gas 2-slagging powder into the molten pool respectively. The multi-media not only improves the overheating problem of the molten pool in the bottom electrode area but also achieves efficient carburization, rapid slag formation, impurity removal and powerful stirring in the molten pool while cooling the bottom electrode. At the same time, the composition and temperature of the molten pool are quickly and evenly distributed to shorten the smelting cycle by at least 3 minutes, the carbon powder yield is increased, and the metal yield is increased by 1˜3%, the smelting end point of phosphorus is less than or equal to 0.005%, and the smelting end point of nitrogen is less than or equal to 50 ppm. Compared with the electric arc furnaces without bottom blowing function, the alloy yield in the tapping alloying process is increased by 4 to 5%.

The above descriptions are only examples of the invention, and are not used to limit the protection scope of the invention. For those skilled in the art, the application can have various modifications and changes. Any modification, equivalent replacement, improvement, etc. made within the spirit and principle of this invention shall be included in the protection scope of this invention.

1. A system for bottom electrode compound bottom blowing of multi-media of DC electric arc furnace, which includes a plurality of bottom electrodes located at the bottom of furnace, some of the bottom electrodes are bottom blowing electrodes with hollow structures, and some of the bottom blowing electrodes are at least one type of Type I bottom electrode, Type II bottom electrode and Type III bottom electrode;
the Type I bottom electrode is used to blow carbonaceous materials into the molten pool to carburize the molten pool to accelerate scrap melting;
the Type II bottom electrode is used to blow slagging powder into the molten pool to form molten slag particles in the molten metal to increase the gas-slag-gold three-phase reaction interface area during the dephosphorization reaction;
the Type III bottom electrode is used to blow gas into the molten pool to accelerate mass transfer in the molten pool;
the system also includes a control unit connected to the bottom blowing electrode to realize online adjustment of the blowing parameters in combination with the power supply intensity of the bottom blowing electrode during the smelting process.

2. The system for bottom electrode compound bottom blowing of multi-media of DC electric arc furnace according to claim 1, characterized in that the Type II bottom electrode and the Type I bottom electrode are arranged adjacent to each other to neutralize the local cold effect produced by the Type I bottom electrode;
the Type III bottom electrode is dispersedly arranged to accelerate the flow at the bottom of the molten pool to strengthen the heat exchange between slag and steel.

3. The system for bottom electrode compound bottom blowing of multi-media of DC electric arc furnace according to claim 1, characterized in that the medium of the carrier gas 1 of the Type I bottom electrode is air, nitrogen or CO₂; the carbonaceous material is carbon powder, coking coal, graphite powder or other carburizing powders.

4. The system for bottom electrode compound bottom blowing of multi-media of DC electric arc furnace according to claim 1, characterized in that the medium of the carrier gas 2 of the Type II bottom electrode is O₂, O₂—N₂ mixed gas or O₂—CO₂ mixed gas; the slagging powder is lime powder or limestone powder.

5. The system for bottom electrode compound bottom blowing of multi-media of DC electric arc furnace according to claim 1, characterized in that the pure gas bottom blowing medium of the Type III bottom electrode is at least one type of mixed gases selected from N₂, Ar, CO₂, and O₂.

6. The system for bottom electrode compound bottom blowing of multi-media of DC electric arc furnace according to claim 1, characterized in that the inner diameter of the cavity of the Type I bottom electrode and the Type II bottom electrode is 4 mm to 25 mm, and the inner diameter of the cavity of the Type III bottom electrode is 0.1 mm to 10 mm.

7. The system for bottom electrode compound bottom blowing of multi-media of DC electric arc furnace according to claim 1, characterized in that the bottom blowing interface of the bottom blowing electrode and the external medium input interface are insulated.

8. The system for bottom electrode compound bottom blowing of multi-media of DC electric arc furnace according to claim 1, characterized in that the bottom blowing electrode is integrally installed at the bottom of the electric arc furnace and is filled and wrapped with materials poured from the furnace bottom.

9. A method for bottom electrode compound bottom blowing of multi-media of DC electric arc furnace, characterized in that some bottom electrode located at the bottom of the furnace is designed as a bottom blowing electrode with a hollow structure, and the bottom blowing electrode is used to blow at least one type of the medium of the gases, carbonaceous materials and slagging powder that can accelerate the mass transfer of the molten pool into the molten pool in the furnace, and it dynamically control the blowing parameters in combination with the power supply strength of the bottom blowing electrode to achieve coordinated operation of bottom blowing and bottom electrode.
